(19) United States
(12) Patent Application Publication
(10) Pub. No.: US 2015/0379217 A1
(43) Pub. Date: Dec. 31, 2015

(54) MEDICAL INFORMATION DISPLAY SYSTEM, SERVER, AND PORTABLE TERMINAL

(71) Applicants: Kabushiki Kaisha Toshiba, Minato-ku (JP); Toshiba Medical Systems Corporation, Otawara-shi (JP)

(72) Inventors: Hiroshizu MORISHIMA, Utsunomiya (JP); Satoshi IGARI, Utsunomiya (JP)

(73) Assignees: Kabushiki Kaisha Toshiba, Minato-ku (JP); Toshiba Medical Systems Corporation, Otawara-shi (JP)

(21) Appl. No.: 14/852,154

(22) Filed: Sep. 11, 2015

Related U.S. Application Data
(63) Continuation of application No. PCT/JP2014/057598, filed on Mar. 19, 2014.

(30) Foreign Application Priority Data
Mar. 28, 2013 (JP) 2013-069626

(51) Int. Cl. G06F 19/00

(52) U.S. Cl. CPC G06F 19/327; G06F 19/322

(57) ABSTRACT

According to one embodiment, a medical information display system includes a storage and processing circuitry. The storage stores a medical information processing application for displaying a processing result or medical information on a display in a hospital in association with a room in the hospital. The processing circuitry is configured to acquire the medical information to be displayed on the display, identify the room where a portable terminal is located, and execute the medical information processing application associated with the room identified to display the processing result or the medical information on the display.

### CROSS-REFERENCE TO RELATED APPLICATION

This application is based upon and claims the benefit of priority from Japanese Patent Application No. 2013-069626, filed 28 Mar. 2013; the entire contents of which are incorporated herein by reference.

### FIELD

Embodiments described herein relate generally to a medical information display system, a server, and a portable terminal.

### BACKGROUND

In recent years, in the medical field, the use of portable terminals (tablet PCs, etc.) in the hospital has been spreading rapidly. In the hospital, doctors carry a portable terminal for use in hospital rooms, operating rooms, or the like.

On the other hand, each hospital often builds an in-hospital system of thin client. In the in-hospital system, a variety of medical information in the hospital (electronic medical records, test information, medical images, etc.) is displayed by applications for medical information processing. Each application and medical information are stored in a server. In this case, a portable terminal accesses the server as a thin client terminal, and thereby can use the application and the medical information.

Besides, in a conference or the like in the medical office, the multiplayer discussion is inevitable. Accordingly, the medical office is provided with a large monitor or a projector (external output device) to display electronic medical records and medical images output thereto. The portable terminal outputs the electronic medical records and the like to the external output device by wired or wireless communication.

The advent of portable terminals enables doctors to access the in-hospital system from different locations in the hospital. However, applications and medical information used by doctors who have a portable terminal vary according to the location (test room, operating room, etc.). This necessitates a doctor to manually switch applications and medical information each time he/she uses the portable terminal in a different place. Such work is troublesome for a person, such as a doctor, who possesses the portable terminal.

In addition, when a doctor makes rounds to hospital rooms, electronic medical records, test results, and the like of each patient in the hospital rooms have been desirably prepared at the time the doctor arrives in the room to efficiently perform the rounds. However, since the doctor makes rounds to a plurality of hospital rooms (patients), he/she is required to switch the electronic medical records and the like for each hospital room (or for each patient). It is difficult for the doctor to switch the electronic medical records and the like while he/she is questioning a patient or moving between hospital rooms. Accordingly, the doctor has to manually switch the electronic medical records and the like after arriving in the hospital room (or when the patient to question changes). Such work is troublesome for a person (doctor, etc.) who possesses the portable terminal.

Further, when a device other than the portable terminal is used as in a conference at the medical office, which requires an external output device, it is necessary to re-log in to a dedicated terminal. Such work is troublesome for a person (doctor, etc.) who possesses the portable terminal.

### BRIEF DESCRIPTION OF THE DRAWINGS

FIG. 1 is a general view of a medical information display system according to a first embodiment;

FIG. 2 is a block diagram of a portable terminal of the first embodiment;

FIG. 3 is a block diagram of a server of the first embodiment;

FIG. 4A is an example of a display of the first embodiment;

FIG. 4B is another example of the display of the first embodiment;

FIG. 5 is a flowchart of the operation of the medical information display system of the first embodiment;

FIG. 6 is a flowchart of the operation of a medical information display system according to a second embodiment;

FIG. 7 is a diagram for explaining a storage according to a third embodiment;

FIG. 8 is a flowchart of the operation of a medical information display system of the third embodiment;

FIG. 9 is a block diagram of a portable terminal according to a modification; and

FIG. 10 is a block diagram of a portable terminal of the modification.

### DETAILED DESCRIPTION

In general, according to one embodiment, a medical information display system includes a storage, a medical information acquiring unit, an identifying unit, and a display controller. The storage stores a medical information processing application for displaying a processing result or medical information on a display in a hospital in association with a room in the hospital. The medical information acquiring unit acquires the medical information to be displayed on the display. The identifying unit identifies the room where a portable terminal is located. The display controller executes the medical information processing application associated with the room identified by the identifying unit to display the processing result or the medical information on the display.

According to another embodiment, a server includes a storage, an identifying unit, and a display controller. The storage stores a medical information processing application for displaying a processing result or medical information on a display in a hospital in association with a room in the hospital. The identifying unit identifies the room where a portable terminal is located. The display controller executes the medical information processing application associated with the room identified by the identifying unit to display the processing result or the medical information on the display.

According to still another embodiment, a portable terminal includes a position information acquiring unit and a display. The position information acquiring unit acquires position information indicating a current position. The display displays medical information or a processing result obtained by execution of a medical information processing application retrieved based on the position information from a plurality of medical information processing applications for displaying the processing result or the medical information on the display in each room in the hospital.

### First Embodiment

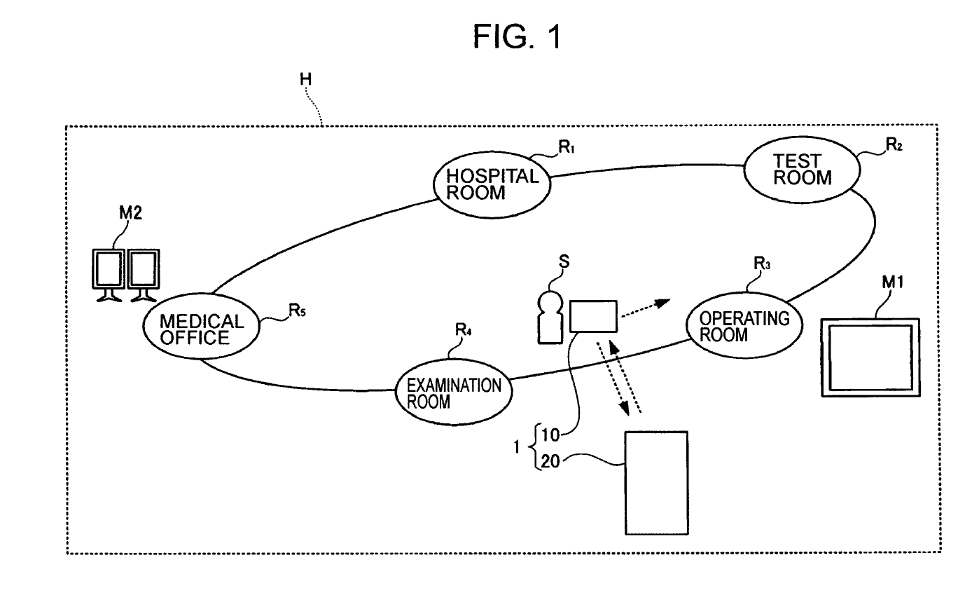

With reference to FIGS. 1 to 5, a description is given of the configuration of a medical information display system 1 according to a first embodiment. The medical information display system 1 includes a portable terminal 10 and a server 20. In this embodiment, a thin client system is described as an example in which the portable terminal 10 accesses the server 20, and a variety of processing is performed on the server 20 side.

### [Overall Configuration of the Medical Information Display System]

FIG. 1 is a schematic diagram illustrating an entire hospital H that includes the medical information display system 1 of this embodiment.

The hospital H has a plurality of rooms for purposes such as examination, test, and the like. As an example, FIG. 1 illustrates a hospital room R₁, a test room R₂, an operating room R₃, an examination room R₄, and a medical office R₅.

Each of the rooms is provided with an external display depending on its purpose. For example, a large monitor M1 is arranged in the operating room R₃. The large monitor M1 displays an image to be referred and an actual operation image during operation (surgery). Besides, a high-resolution monitor M2 is arranged in the medical office R₅. The high-resolution monitor M2 displays an image obtained in the test room R₂ and the like for interpretation. Note that the rooms provided with the external display are not limited to them. The external display of the embodiment (the large monitor M1 and the high-resolution monitor M2) is examples of “display”. The term “external” of the external display indicates that it is a device that is provided separately from the portable terminal 10.

The portable terminal 10 may be a tablet PC (mobile terminal) that an operator S carries. The operator S is a doctor or the like who uses the portable terminal 10 (hereinafter, a doctor is described as an example of the operator S). While moving in the hospital H, the doctor carries the portable terminal 10 to use it in each room. The details of the portable terminal 10 are described later.

Under thin client environment, the server 20 manages a plurality of applications and medical information. The details of the server 20 are described later. Note that the server 20 may be located outside the hospital H.

The portable terminal 10 and the server 20 are communicably connected via a network such as a local area network (LAN). Although it is desirable that the communication conform to the Digital Imaging and Communications in Medicine (DICOM) standard for medical images, other standards may be applicable as appropriate. Information communication is based on Transmission Control Protocol/Internet Protocol (TCP/IP), which is a standard communication protocol for network communications. Data is exchanged in packets (basic unit of information to be transferred) via a network. The portable terminal 10 and the server 20 of this embodiment are an example of the “medical information display system”.

### [Configuration of the Portable Terminal 10]

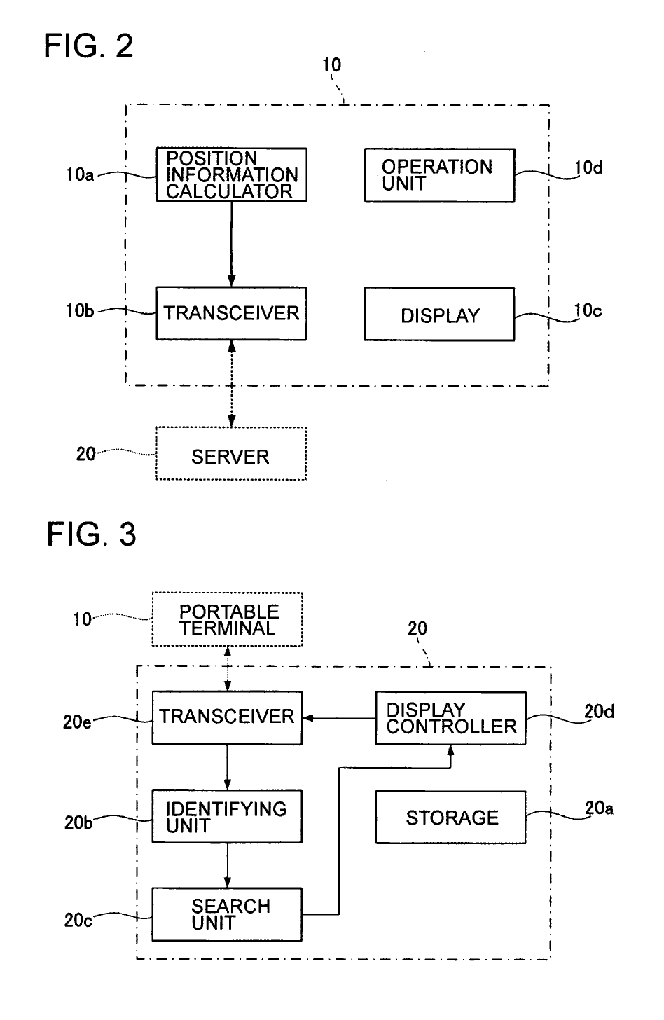

As illustrated in FIG. 2, the portable terminal of the embodiment includes a position information calculator 10a, a transceiver 10b, a display 10c, and an operation unit 10d.

The position information calculator 10a obtains position information indicating a current position of the portable terminal 10. The current position refers to the position of the portable terminal 10 in the hospital H (the location of the doctor who carries the portable terminal 10). In this embodiment, the position information calculator 10a calculates three-dimensional coordinates as the position information using the Global Positioning System (GPS). Specifically, the position information calculator 10a receives signals from a plurality of satellites (not illustrated), and determines the distance to each of the satellites based on the signals to thereby obtain the three-dimensional coordinates of the portable terminal 10. The calculation of the position information may be performed continuously, or may be performed every predetermined time set in advance. The position information need not necessarily be calculated by using the GPS. For example, the position information calculator 10a may obtain the position information based on signals from a wireless base station. Alternatively, the position information calculator 10a may obtain the position information based on an identification signal from an RF tag provided in each room. In this case, the RF tag stores in advance the position information (three-dimensional coordinates) of the room. The position information calculator 10a of this embodiment corresponds to an example of the “position information obtaining unit”. The position information is not limited to that obtained by calculation as described above.

The transceiver 10b transmits and receives signals and data between the portable terminal 10 and the server 20. For example, the transceiver 10b transmits the position information obtained by the position information calculator 10a to the server 20. In addition, the transceiver 10b receives medical information sent from the server 20. The medical information indicates data relating to a patient such as electronic medical record, test information, medical image, and the like. In this embodiment, the medical information includes at least one of an electronic medical record, test information, and a medical image. The medical information may include any information used in the hospital H as a medical institution. The transceiver 10b of this embodiment corresponds to an example of the “medical information acquiring unit”. The position information may be transmitted according to the timing of acquiring the position information, or may be once stored in a memory (not illustrated) and transmitted at a predetermined timing. Incidentally, the server 20 may be configured to retrieve the position information stored in the memory (not illustrated) at a predetermined timing.

The display 10c displays the medical information and the like sent from the server 20. The display 10c of this embodiment corresponds to an example of the “display”.

The operation unit 10d is used as an input device to enter instructions to the portable terminal 10. The operation unit 10d may include, for example, a keyboard, a mouse, a trackball, a joystick, or the like. Alternatively, a graphical user interface (GUI) displayed on the display 10c may be used as the operation unit 10d.

### [Configuration of the Server 20]

As illustrated in FIG. 3, the server 20 of this embodiment includes a storage 20a, an identifying unit 20b, a search unit 20c, a display controller 20d, and a transceiver 20e.

The storage 20a is formed of a semiconductor memory such as RAM or ROM. The storage 20a stores a plurality of applications for setting the type of medical information to be displayed on the display and performing predetermined medical information processing, each in association with a room in the hospital H. The storage 20a also stores setting information for setting the display mode of medical information to be displayed by the application.

The applications are software for setting the type of medical information to be displayed on the display (what kind of medical information is to be displayed on the display) and performing predetermined medical information processing. Examples of the medical information processing include generating medical information in response to the input of new information such as test information and doctor's findings, updating the contents of medical information already registered, and processing the medical information already registered. The storage 20a stores a plurality of applications, each of which is associated with a room in the hospital H. For example, the storage 20a stores software, which enables an electronic medical record and a medical image to be displayed on the display, as an application for the hospital room R₁ in association with the coordinates of the hospital room R₁. The storage 20a may store software, which allows input of information on a patient such as the body temperature and blood pressure of the patient and doctor's findings, as an application for the hospital room R₁ in association with the coordinates of the hospital room R₁. In this case, doctors, nurses, and the like can generate medical information in the hospital room R₁ by providing information on a patient such as the body temperature and blood pressure of the patient. The storage 20a also stores software, which enables test information and a medical image to be displayed on the display, as an application for the operating room R₃ in association with the coordinates of the operating room R₃. The application of the embodiment corresponds to an example of the “medical information processing application”.

The setting information is information for setting display mode of the medical information to be displayed by the application (how to display the medical information). For example, the storage 20a stores the setting information for displaying test information on the display 10c and a medical image on the large monitor M1. The storage 20a stores a plurality of patterns of setting information for setting different display modes. The doctors can select setting information for setting a predetermined display mode from the patterns using the operation unit 10d or the like. Alternatively, specific setting information may be determined in advance with respect to each room.

The storage 20a may store a plurality of applications corresponding to the types of medical information to be displayed. In this case, medical information can be displayed on the display in a specific display mode corresponding to the medical information by each application.

Further, in this embodiment, the storage 20a stores installation information indicating the presence or absence of an external display in the rooms in the hospital H. The storage 20a also stores medical information for a plurality of patients, and the position (coordinates) of each room in the hospital H.

Having received the position information, the identifying unit 20b identifies the room where the portable terminal 10 is located. Specifically, the identifying unit 20b compares the position information (three-dimensional coordinates) obtained by the position information calculator 10a with the position (three-dimensional coordinates of a predetermined area) of each room in the hospital H stored in the storage 20a, and identifies a room corresponding to an area including the position information as the room where the portable terminal is located. That is, the room where the portable terminal 10 is located may include an area in the vicinity of the room.

The search unit 20c searches the storage 20a for an application associated with the identified room. Specifically, the search unit 20c selects a dedicated application having the same coordinates as those of the room identified by the identifying unit 20b from the applications in the storage 20a.

In this embodiment, the search unit 20c detects whether an external display is installed in the identified room based on the installation information. Specifically, the search unit 20c retrieves the installation information corresponding to the room identified by the identifying unit 20b from the storage 20a to determine the presence or absence of an external display in the room.

The display controller 20d executes the application thus retrieved, and causes the display to display the processing result of the application or the medical information in a predetermined display mode based on the setting information. More specifically, when an external display is installed in the identified room, the processing result of the application or the medical information is displayed on the external display as well as the display 10c under the control of the display controller 20d. On the other hand, when an external display is not installed in the identified room, the processing result of the application or the medical information is displayed on the display 10c under the control of the display controller 20d. The processing result of the application of the embodiment is a result of medical information processing. If the medical information processing is processing of generating medical information in response to the input of new information such as test information and doctor's findings, the processing result of the application is the input new information and the generated medical information. If the medical information processing is processing of updating the contents of medical information already registered, the processing result of the application is updated medical information. If the medical information processing is processing of the medical information already registered, the processing result of the application is the processing result of the medical information.

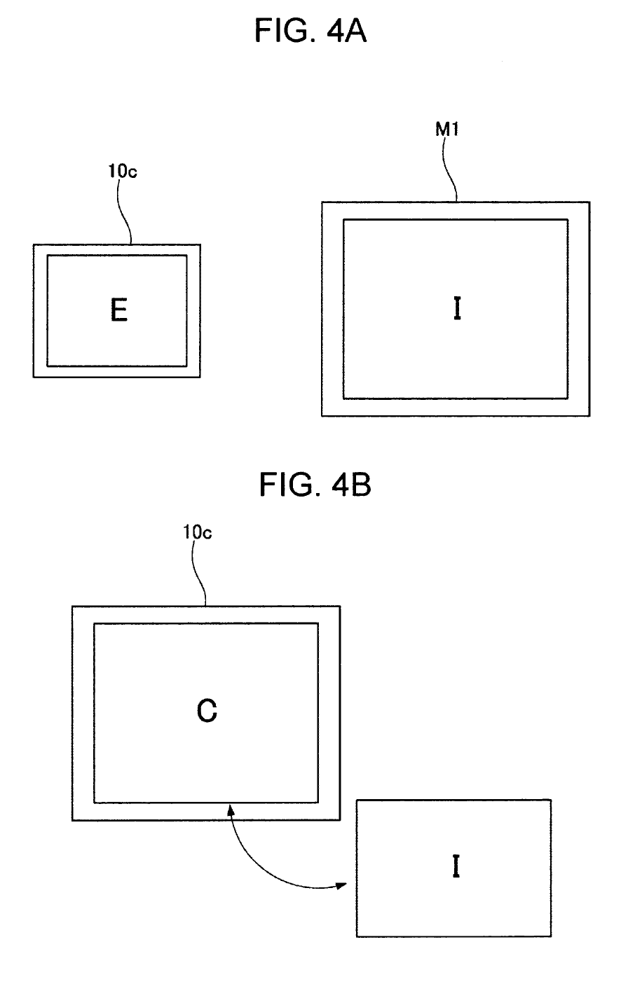

Described below is an example in which the room where the portable terminal 10 is located is identified as the operating room R₃ where the large monitor M1 is installed. In this case, the display controller 20d retrieves an application (an application for displaying test information and a medical image) for the operating room R₃ retrieved by the search unit 20c from the storage 20a. The display controller 20d receives, from the search unit 20c, the determination result of the presence or absence of an external display in the identified room, and specifies the large monitor M1 and the display 10c of the portable terminal 10 to display medical information (test information or a medical image). The display controller 20d then executes the application with respect to the large monitor M1 and the display 10c of the portable terminal 10, and displays the test information and the medical image in a predetermined display mode based on the setting information selected through the operation unit 10d or the like. For example, as the predetermined display mode, the display controller 20d displays a medical image I on the large monitor M1 and test information E on the display 10c (see FIG. 4A). By selecting a predetermined display mode, even if an external display is installed, the display controller 20d can display the medical information on only one of the displays. It is preferable that the display controller 20d make sure that the large monitor M1 is actually available (the large monitor M1 has not been moved from the operating room R₃, the large monitor M1 has no failure, etc.) before the above operation. In this case, for example, the display controller 20d sends a check signal to the external display in the identified room, and detects a response to the check signal. Having confirmed the availability of the large monitor M1, the display controller 20d performs the above operation. Alternatively, the display controller 20d may check whether there is an external display in the identified room each time it performs the above operation without using the installation information.

Described below is another example in which the room where the portable terminal 10 is located is identified as the hospital room R₁ where an external display is not installed. In this case, the display controller 20d retrieves, from the storage 20a, an application (an application for displaying a medical image and an electronic medical record) for the hospital room R₁ retrieved by the search unit 20c. The display controller 20d receives, from the search unit 20c, the determination result of the presence or absence of an external display in the identified room, and specifies only the display 10c of the portable terminal 10 to display medical information (a medical image and an electronic medical record). The display controller 20d then executes the application with respect to the display 10c of the portable terminal 10, and displays a medical image and an electronic medical record in a predetermined display mode based on the setting information selected through the operation unit 10d or the like. For example, as the predetermined display mode, the display controller 20d displays an electronic medical record C on the display 10c. Then, the display controller 20d switches the display of the electronic medical record C to the medical image I based on an instruction provided through the operation unit 10d or the like (see FIG. 4B).

Alternatively, the display controller 20d retrieves an application (an application for updating medical information) for the hospital room R₁ retrieved by the search unit 20c from the storage 20a. The display controller 20d receives, from the search unit 20c, the determination result of the presence or absence of an external display in the identified room, and specifies only the display 10c of the portable terminal 10 to display medical information (a medical image or an electronic medical record). The display controller 20d then executes the application with respect to the display 10c of the portable terminal 10, and displays a medical image and an electronic medical record in a predetermined display mode based on the setting information selected through the operation unit 10d or the like. The display controller 20d receives the input of information (body temperature, blood pressure, etc.) on a patient through the operation unit 10d, and updates the display contents as well as updating the medical information.

Note that when the position information (coordinates) from the position information calculator 10a deviates from the identified room (coordinates), i.e., when the doctor moves from the room, the display controller 20d terminates the running application. Then, the display controller 20d executes an application associated with the identified room based on new position information.

Besides, after displaying medical information on the display based on certain setting information, the display controller 20d may change it to different setting information based on an instruction received through the operation unit 10d, and display the medical image in a display mode based on the different setting information (change the display mode of the medical information displayed first). That is, the operation unit 10d can be used to select any of a plurality of pieces of setting information.

The transceiver 20e transmits and receives signals and data between the portable terminal 10 and the server 20. For example, when a doctor enters the patient ID of a patient in the identified room using the operation unit 10d or the like, the display controller 20d retrieves medical information corresponding to the patient ID from the storage 20a. The transceiver 20e transmits the medical information to the portable terminal 10. The medical information is displayed on the display 10c under the control of the display controller 20d.

### [Operation]

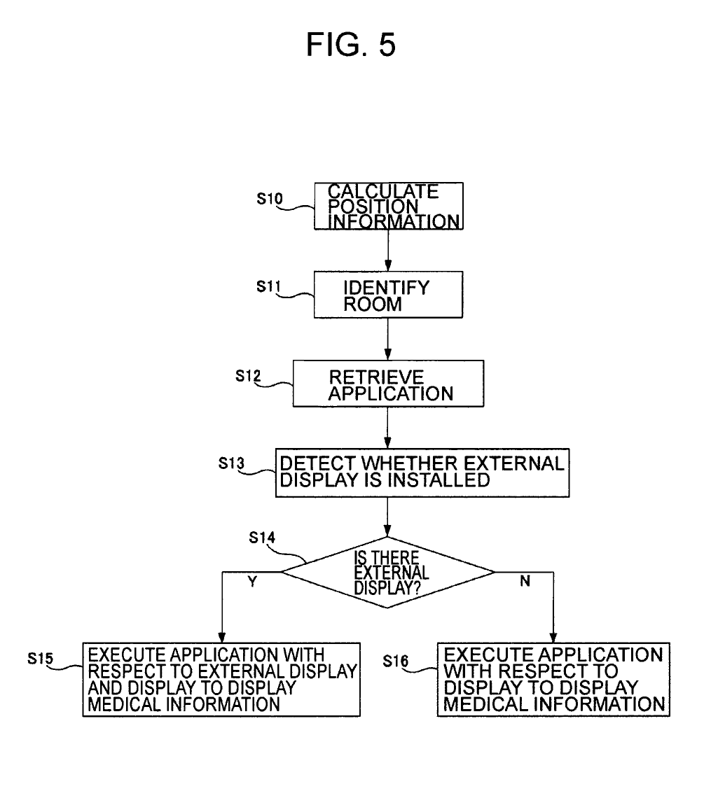

Next, with reference to FIG. 5, a description is given of the operation of the medical information display system 1 of this embodiment.

Following the pre-planned schedule, the doctor moves in the hospital H with the portable terminal 10.

The position information calculator 10a calculates position information indicating the current position of the portable terminal 10 by using the GPS (S10). The transceiver 10b transmits the position information to the server 20.

The identifying unit 20b receives the position information obtained in step S10, and identifies a room in the hospital H corresponding to the position information (S11).

The search unit 20c searches the storage 20a for an application associated with the room identified in step S11 (S12).

In addition, the search unit 20c detects whether an external display is installed (the presence or absence of an external display) in the room identified in step S11 based on the installation information stored in the storage 20a (S13). Incidentally, steps S12 and S13 may be performed in parallel, or may be performed in the reverse order.

When an external display is installed (e.g., when the identified room is the operating room R₃; Y in step S14), the display controller 20d executes the application retrieved in step S12 with respect to the large monitor M1 and the display 10c of the portable terminal 10, and displays medical information (e.g., test information and a medical image) in a predetermined display mode based on the setting information (S15).

On the other hand, when there is no external display installed (e.g., when the identified room is the hospital room R₁; N in step S14), the display controller 20d executes the application retrieved in step S12 with respect to the display 10c of the portable terminal 10, and displays medical information (e.g., a medical image and an electronic medical record) in a predetermined display mode based on the setting information (S16).

Here, when the patient ID of a patient in the identified room is entered through the operation unit 10d or the like, the display controller 20d retrieves medical information corresponding to the patient ID from the storage 20a, and displays it on the large monitor M1 and the display 10c (or the display 10c only). Although FIG. 5 illustrates an example in which the medical information is displayed, the processing result of the application may be displayed.

Note that the configuration of the portable terminal 10 and the server 20 is not limited to the above. For example, the display controller 20d to start the application may be provided to the portable terminal 10 side. That is, the medical information display system 1 of this embodiment is not limited to the thin client system.

According to this embodiment, the medical information display system 1 includes the position information calculator 10a, the storage 20a, the identifying unit 20b, the search unit 20c, and the display controller 20d. The position information calculator 10a calculates the position information indicating a current position of the portable terminal 10. The storage 20a stores a plurality of applications for setting the type of medical information to be displayed on the display, each in association with a room in the hospital H, and also setting information for setting the display mode of medical information to be displayed by each of the applications. Having received the position information, the identifying unit 20b identifies the room where the portable terminal 10 is located. The search unit 20c searches the storage 20a for an application associated with the identified room. The display controller 20d executes the application, and displays, on the display, the medical information in a predetermined display mode based on the setting information.

As described above, according to this embodiment, the medical information display system automatically executes the application associated with the room where the portable terminal 10 is located based on the position information of the portable terminal 10, thereby displaying the medical information on the display. Accordingly, the doctor or the like is not required to manually start a necessary application each time he/she moves to another room. That is, with the medical information display system 1, the display control can be performed easily according to the location of the portable terminal 10.

According to this embodiment, the medical information display system 1 includes the portable terminal 10 and the server 20 that is communicably connected to the portable terminal 10. The portable terminal 10 includes the position information calculator 10a. The position information calculator 10a calculates the position information indicating the current position of the portable terminal 10. The server 20 includes the storage 20a, the identifying unit 20b, the search unit 20c, and the display controller 20d. The storage 20a stores a plurality of applications for setting the type of medical information to be displayed on the display, each in association with a room in the hospital H, and also setting information for setting the display mode of medical information to be displayed by each of the applications. Having received the position information, the identifying unit 20b identifies the room where the portable terminal 10 is located. The search unit 20c searches the storage 20a for an application associated with the identified room. The display controller 20d executes the application, and displays, on the display, the medical information in a predetermined display mode based on the setting information.

In this manner, even in the medical information display system 1 of thin client in which the portable terminal 10 used by the doctor or the like performs only necessary minimum processing, and other processing is performed by the server 20, the display control can be performed easily according to the location of the portable terminal 10.

Further, in the medical information display system 1 of the embodiment, the display is an external display (the large monitor M1, the high-resolution monitor M2, etc.) arranged in rooms in the hospital H and the display 10c of the portable terminal 10. The storage 20a stores installation information indicating the presence or absence of an external display in the rooms in the hospital H. The search unit 20c detects whether an external display is installed in the identified room based on the installation information. When an external display is installed in the room, the display controller 20d displays the medical information on the external display as well as the display 10c. When an external display is not installed in the room, the display controller 20d displays the medical information on the display 10c.

As described above, according to this embodiment, the medical information display system 1 executes the application retrieved according to the presence or absence of an external display, thereby displaying the medical information on the display. Accordingly, the doctor or the like is not required to re-login to a dedicated terminal even when he/she has moved to another room where there is an external display such as a large monitor. That is, with the medical information display system 1, the display control can be performed easily according to the location of the portable terminal 10.

According to this embodiment, the medical information display system 1 includes the storage 20a, the transceiver 10b, the identifying unit 20b, and the display controller 20d. The storage 20a stores an application (medical information processing application) to display a processing result or medical information on the display in each room of the hospital in association with the room. The transceiver 10b acquires medical information to be displayed on the display. The identifying unit 20b identifies the room where the portable terminal 10 is located. The display controller 20d executes an application associated with the room identified by the identifying unit 20b, and thereby displays the processing result or the medical information on the display.

The medical information display system 1 of this embodiment may include the position information calculator 10a (position information acquiring unit). The position information calculator 10a obtains the position information indicating the current position of the portable terminal 10. The identifying unit 20b identifies the room where the portable terminal 10 is located based on the position information obtained by the position information calculator 10a.

In the medical information display system 1 of this embodiment, the portable terminal 10 may include the display 10c. The display 10c displays the processing result of an application or medical information. The display controller 20d displays the processing result or the medical information on the display 10c.

Further, in the medical information display system 1 of this embodiment, the storage 20a may store installation information of the display installed correspondingly in the room. In this case, when a display is installed in an identified room, the display controller 20d may display the processing result or the medical information on the display.

Still further, in the medical information display system 1 of this embodiment, the storage 20a may store a plurality of applications each corresponding to the type of medical information to be displayed.

Still further, in the medical information display system 1 of this embodiment, the medical information may include at least one of an electronic medical record, test information, and a medical image.

Still further, in the medical information display system 1 of this embodiment, the display may include a plurality of displays. In this case, the display controller may specify one of the displays to display medical information according to the type of the medical information to be displayed, and display a processing result or the medical information on the display specified.

### Second Embodiment

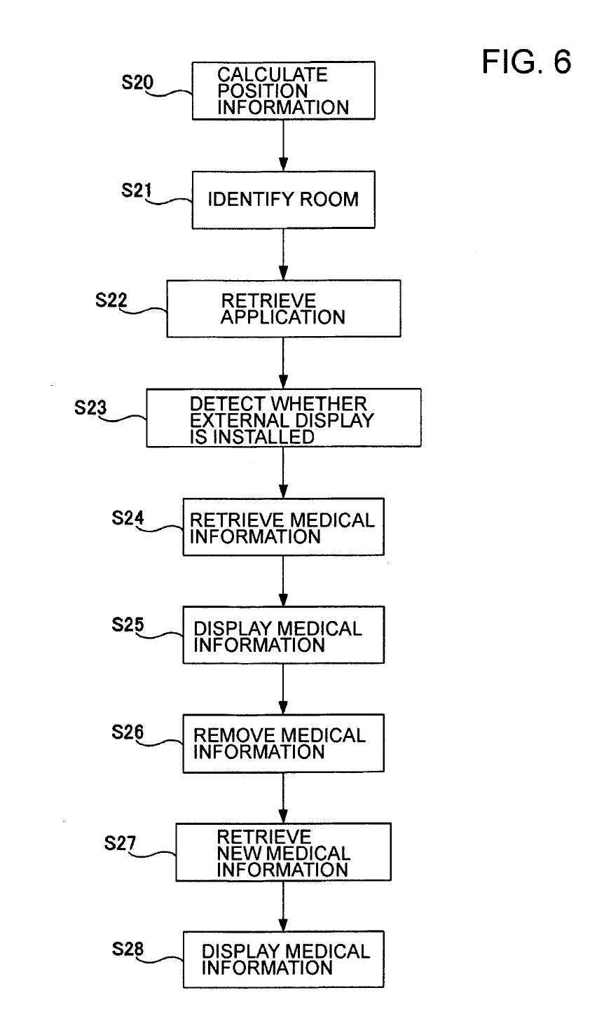

Next, with reference to FIG. 6, a description is given of the configuration of the medical information display system 1 according to a second embodiment. In this embodiment, the medical information display system 1 is capable of displaying medical information associated with an identified room. Regarding the same configuration as in the first embodiment, a detailed description may not be provided.

### [Configuration of the Server 20]

As in the first embodiment, the server 20 includes the storage 20a, the identifying unit 20b, the search unit 20c, the display controller 20d, and the transceiver 20e.

The storage 20a of this embodiment stores medical information associated with a room in the hospital H. For example, the storage 20a stores medical information on a patient who is hospitalized in the hospital room R₁ in association with the coordinates of the hospital room R₁.

The search unit 20c searches the storage 20a for medical information associated with the identified room. Specifically, the search unit 20c selects medical information having the same coordinates as those of the identified room from a plurality of pieces of medical information stored in the storage 20a.

The display controller 20d displays the medical information thus retrieved on the display based on the type of the medical information set to an application retrieved. Described below is an example in which a patient P is hospitalized in the hospital room R₁ where an external display is not installed. In this case, when the room where the portable terminal 10 is located is identified as the hospital room R₁, the display controller 20d executes an application (an application for displaying a medical image and an electronic medical record) for the hospital room R₁ with respect to the display 10c of the portable terminal 10. Then, the display controller 20d displays the medical information (the medical image and the electronic medical record) of the patient P on the display 10c according to the application.

A doctor often makes rounds to a plurality of hospital rooms. In general, the type of medical information required in the hospital rooms is known. That is, since the same application is used in the hospital rooms, it is desirable that the application be kept running. On the other hand, it is undesirable from the viewpoint of personal information protection to leave the medical information displayed on the display 10c of the portable terminal 10. Therefore, when the position information (coordinates) from the position information calculator 10a deviates from the range of the identified room, i.e., when the doctor moves from the room, the display controller 20d can remove only the medical information displayed on the display 10c. In this case, the display controller 20d displays, on the display 10c, medical information associated with the identified room based on new position information. This prevents the medical information of a patient from being exposed to others in a hospital room where the doctor or the like has moved to.

### [Operation]

Next, with reference to FIG. 6, a description is given of the operation of the medical information display system 1 of this embodiment. In the following, it is assumed that only one patient stays in each hospital room.

Following the pre-planned schedule, the doctor makes rounds to a plurality of hospital rooms with the portable terminal 10.

The position information calculator 10a calculates position information indicating a current position of the portable terminal 10 by using the GPS (S20). The transceiver 10b transmits the position information to the server 20.

The identifying unit 20b receives the position information obtained in step S20, and identifies a room corresponding to the position information as the hospital room R₁ (S21).

The search unit 20c searches the storage 20a for an application (an application for displaying a medical image and an electronic medical record) associated with the hospital room R₁ identified in step S21 (S22).

In addition, the search unit 20c detects whether an external display is installed (the presence or absence of an external display) in the room identified in step S21 based on the installation information stored in the storage 20a (S23). Here, it is assumed that there is no external display installed in the hospital room.

Besides, the search unit 20c retrieves medical information associated with the hospital room R₁ identified in step S21, i.e., the electronic medical record and the medical image of the patient hospitalized in the hospital room R₁ (S24). Incidentally, steps S22 to S24 may be performed in parallel, or may be performed in an arbitrary order.

The display controller 20d executes the application retrieved in step S22, and displays, on the display 10c, the medical information retrieved in step S24 based on the type of the medical information set in the application (S25).

When the doctor leaves the hospital room R₁ after checking in on the patient in the hospital room R₁ (when the position information of the portable terminal 10 falls out of the range of the coordinates of the hospital room R₁), the display controller 20d removes the medical information displayed in step S25 (S26).

When the identifying unit 20b identifies a new room as a hospital rooms R₁′, the search unit 20c retrieves new medical information associated with the hospital room R₁′ (S27). The display controller 20d displays, on the display 10c, the medical information retrieved in step S27 based on the type of the medical information set to the application retrieved in step S22 (S28).

According to this embodiment, the medical information display system 1 stores medical information in the storage 20a in association with a room in the hospital H. The search unit 20c retrieves medical information associated with the identified room. The display controller 20d displays, on the display, the medical information thus retrieved based on the type of the medical information set to the application retrieved.

As described above, according to this embodiment, the medical information display system automatically displays medical information associated with the room where the portable terminal 10 is located based on the position information of the portable terminal 10. Accordingly, the doctor or the like is not required to manually display necessary medical information each time he/she moves to another room. That is, with the medical information display system 1, the display control can be performed easily according to the location of the portable terminal 10.

In the medical information display system 1 of this embodiment, the storage 20a may store medical information associated with a room in the hospital. In this case, the transceiver 10b (medical information acquiring unit) acquires medical information associated with the identified room from the storage 20a.

### Third Embodiment

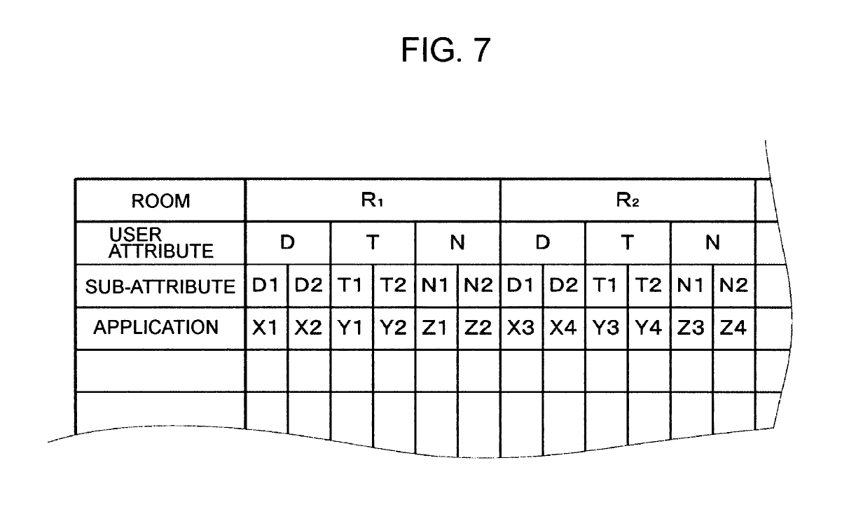

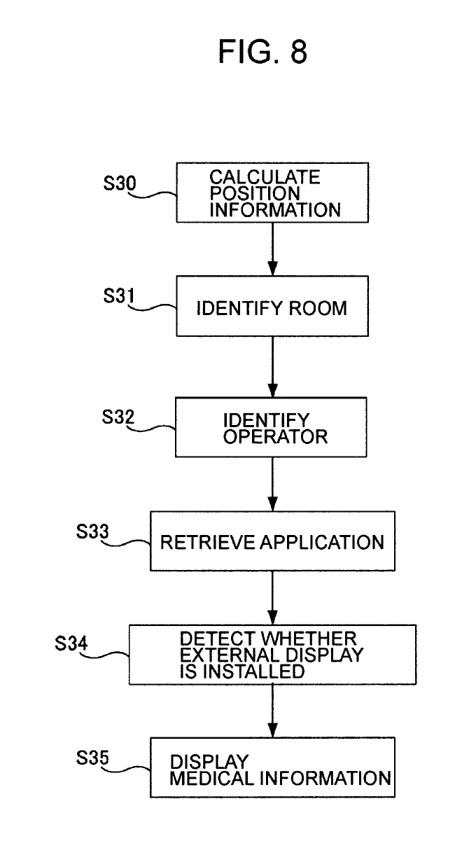

Next, with reference to FIGS. 7 and 8, a description is given of the configuration of the medical information display system 1 according to a third embodiment. In this embodiment, the medical information display system 1 is capable of executing a different application from among a plurality of applications associated with the identified room according to the operator of the portable terminal 10. Regarding the same configuration as in the first embodiment, a detailed description may not be provided.

### [Configuration of the Server 20]

As in the first embodiment, the server 20 includes the storage 20a, the identifying unit 20b, the search unit 20c, the display controller 20d, and the transceiver 20e.

As illustrated in FIG. 7, the storage 20a of this embodiment stores a plurality of applications each of which is associated with the operator of the portable terminal 10 as well as a room in the hospital H. That is, the storage 20a stores a plurality of applications each of which is associated with a combination of a room in the hospital H and the operator of the portable terminal 10.

The operator of the portable terminal 10 is identified by the login ID of the portable terminal 10. In this embodiment, the login ID is assigned a user attribute and a sub-attribute in advance. For example, a user attribute D represents “doctor”, a user attribute T represents “operator”, and a user attribute N represents “nurse”. For example, according to the sub-attribute, “doctor” is classified into primary doctor (sub-attribute D1) and resident physician (sub-attribute D2). Likewise, for example, “operator” is classified into sub-attributes T1 and T2, and “nurse” is classified into sub-attributes N1 and N2.

The storage 20a stores applications each in association with a sub-attribute related to the operator of the portable terminal 10 with respect to each room such as the hospital room R₁ and the test room R₂. Although FIG. 7 illustrates only the hospital room R₁ and the test room R₂, the same applies to the operating room R₃, the examination room R₄, and the medical office R₅. With this, it is possible to identify an application that is associated with the login ID of the portable terminal 10 from the storage 20a.

Specifically, in the portable terminal 10, the transceiver 10b transmits the login ID of the portable terminal 10 to the server 20 together with the position information.

In the server 20, the identifying unit 20b receives the position information, and identifies the room where the portable terminal 10 is located. Besides, the search unit 20c receives the login ID, and searches the storage 20a for an application associated with both a user attribute and a sub-attribute related to the login ID and the room identified by the identifying unit 20b. The display controller 20d executes the application retrieved by the search unit 20c, and thereby displays a processing result or medical information on the display.

Thus, it is possible to execute an application corresponding to the operator of the portable terminal 10 depending on the room identified by the identifying unit 20b.

### [Operation]

Next, with reference to FIG. 8, a description is given of the operation of the medical information display system 1 of this embodiment.

Following the pre-planned schedule, the doctor makes rounds to a plurality of hospital rooms with the portable terminal 10 that the doctor has logged in in advance.

The position information calculator 10a calculates position information indicating a current position of the portable terminal 10 by using the GPS (S30). The transceiver 10b transmits the position information and the login ID of the doctor who has logged in the portable terminal 10 to the server 20.

The identifying unit 20b receives the position information calculated in step S30, and identifies a room corresponding to the position information as the hospital room R₁ (S31).

Having received the login ID transmitted from the portable terminal 10 in step S30, the search unit 20c identifies the operator corresponding to the login ID (S32). In the embodiment, the search unit 20c specifies a user attribute and a sub-attribute associated with the operator.

The search unit 20c searches the storage 20a for an application (an application for displaying a medical image and an electronic medical record) associated with the room identified in step S31 as well as the user attribute and the sub-attribute specified in step S32 (S33).

In addition, the search unit 20c detects whether an external display is installed (the presence or absence of an external display) in the room identified in step S31 based on the installation information stored in the storage 20a (S34).

The display controller 20d executes the application retrieved in S33, and displays a processing result or medical information on the display or the external display based on the installation information retrieved in S34 (S35).

Although an example is described in connection with FIG. 8, in which the doctor makes rounds to a plurality of hospital rooms with the portable terminal 10 that the doctor has logged in in advance, this is not so limited. The portable terminal 10 may send a login ID to the server 20 together with the position information each time its operator changes to enable the execution of an application associated with both the operator and a room in the hospital H.

In the medical information display system 1 of this embodiment, the storage 20a stores an application associated with both the room identified by the identifying unit 20b and the operator of the portable terminal 10. The display controller 20d executes the application associated with both the room identified by the identifying unit 20b and the operator of the portable terminal 10, and thereby displays the processing result of the application or medical information on the display.

As described above, according to this embodiment, the medical information display system is capable of executing an application corresponding to the operator of the portable terminal 10 with respect to the room identified by the identifying unit 20b. This eliminates the need for the doctor or the like to manually execute necessary application each time he/she moves to another room. That is, with the medical information display system 1, the display control can be performed easily according to the location of the portable terminal 10 and its operator.

### <Modification>

For example, if a plurality of patients are hospitalized in one hospital room, medical information cannot be specified for each patient by the configuration described in the second embodiment.

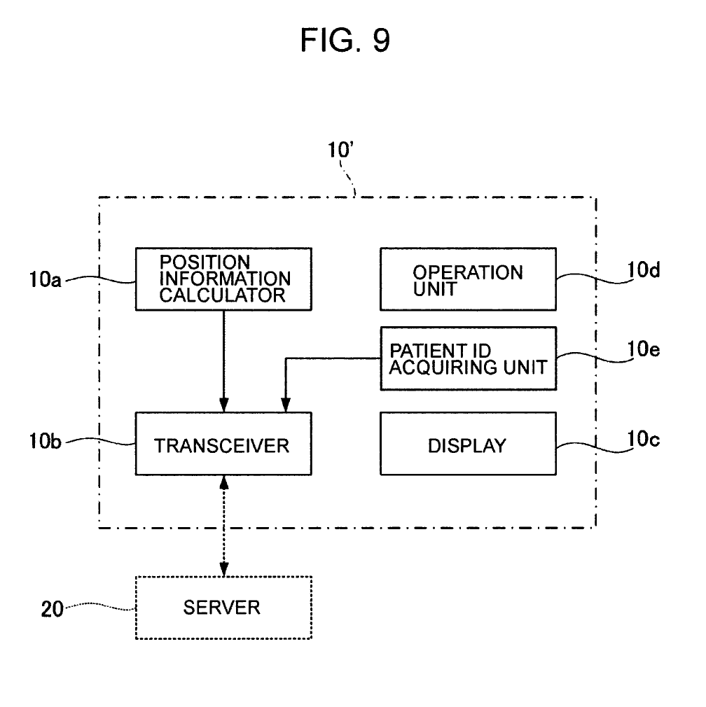

In this case, the doctor or the like enters a patient ID that specifies a patient of interest through the portable terminal. Specifically, as illustrated in FIG. 9, a portable terminal 10′ includes the position information calculator 10a, the transceiver 10b, the display 10c, the operation unit 10d, and a patient ID acquiring unit 10e. When the doctor or the like enters a patient ID through the operation unit 10d, the patient ID acquiring unit 10e acquires the patient ID. The transceiver 10b transmits the patient ID to the server 20 together with the position information. In the server 20, the search unit 20c retrieves medical information corresponding to the patient ID from pieces of medical information associated with the identified room. The display controller 20d displays the medical information thus retrieved (the medical information of the patient of interest only) on the display.

Incidentally, the patient ID acquiring unit 10e need not always acquire a patient ID from the input provided through the operation unit 10d. For example, the patient ID acquiring unit 10e may obtain the patient ID by reading a bar code or the like that specifies the patient.

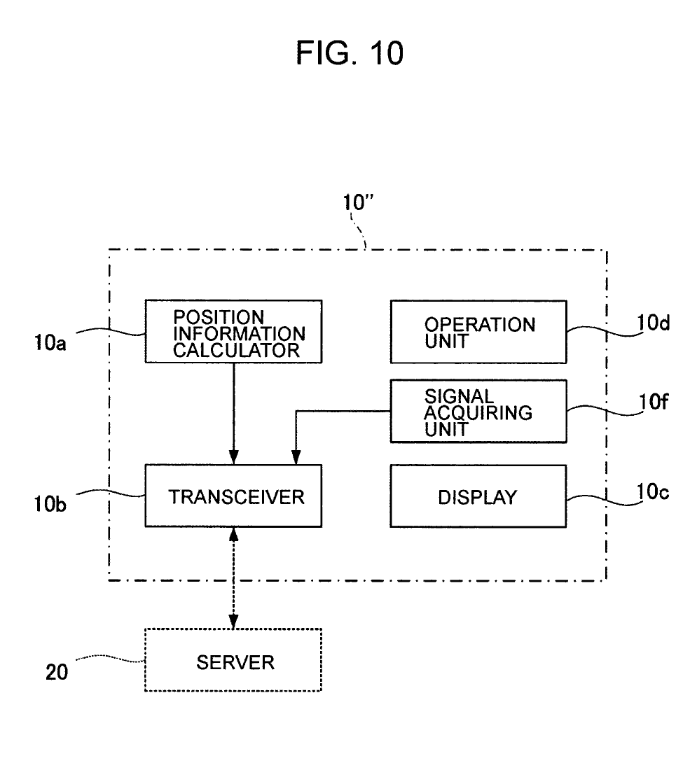

Besides, there is a case that an RF tag is attached to the name tag or the arm of each patient for identifying the patient. In this case, based on an identification signal from the RF tag attached to the patient (subject), the search unit 20c may retrieve medical information corresponding to the identification signal from pieces of medical information of patients associated with the identified room. Specifically, as illustrated in FIG. 10, a portable terminal 10″ includes the position information calculator 10a, the transceiver 10b, the display 10c, the operation unit 10d, and a signal acquiring unit 10f. The signal acquiring unit 10f acquires an identification signal from the RF tag provided to a patient (subject). When the doctor who carries the portable terminal 10″ approaches a patient having an RF tag, the signal acquiring unit 10f (detector) of the portable terminal 10″ receives an identification signal. The transceiver 10b transmits the identification signal to the server 20 together with the position information. The identification signal received by the server 20 is sent to the search unit 20c. The search unit 20c retrieves medical information of a patient corresponding to the identification signal from pieces of medical information associated with the identified room. The display controller 20d displays, on the display, only the medical information of the patient corresponding to the identification signal. Incidentally, if the portable terminal 10″ receives a different identification signal by the signal acquiring unit 10f while displaying the medical information of the patient (or if no identification signal is received), it can be determined that the visit to the patient is completed, and the doctor is about to check in on a new patient. Accordingly, the transceiver 10b transmits the identification signal of the new patient detected by the signal acquiring unit 10f to the server 20. Having received the identification signal of the new patient, the display controller 20d removes the medical information currently being displayed, and displays, on the display, medical information of the new patient retrieved by the search unit 20c. In this manner, by using an identification signal from the RF tag, even when the position information of the portable terminal 10″ remains the same, only specific medical information can be retrieved easily from a plurality of pieces of medical information associated with the position. Besides, upon receipt of a different identification signal, medical information currently being displayed is automatically removed. Thus, it is possible to prevent the medical information of a patient from being exposed to others.

Alternatively, for example, a work list created in the hospital may be used. The work list is intended to present the contents of work performed by a doctor (operator) in time series to manage the work. In the work list, a scheduled time is set with respect to each task for performing the task. The work list is stored in, for example, the storage 20a of the server 20. The doctor can refer to his/her work list at any time by making an access to the server 20 from the portable terminal 10 (10′, 10″).

In this case, based on the time indicated in the work list, the search unit 20c can retrieve medical information corresponding to the time from pieces of medical information associated with the identified room. For example, it is assumed that, in the work list, the time to make rounds to patients in the hospital room R₁ is set as follows: visit a patient A at 14:30, a patient B at 14:45, and a patient C at 15:00. If the current time is 14:45, then, to retrieve medical information on a particular patient from pieces of medical information associated with the identified room, the search unit 20c searches for the medical information of the patient B based on the current time (14:45). The display controller 20d displays only the medical information of the patient B thus retrieved on the display.

The identifying unit 20b may identify the room where the portable terminal 10 (10′, 10″) is located without receiving the position information. For example, the portable terminal 10 (10′, 10″) may be detected in each room so that the detection result is sent to the server 20 therefrom. In this case, the portable terminal 10 (10′, 10″) is provided with a transmitter for transmitting its identification signal. In the server 20, the identifying unit 20b identifies the room where the portable terminal 10 (10′, 10″) is located based on the detection result. In this case also, a detector need not necessarily be used to detect whether the portable terminal 10 (10′, 10″) enters the room.

Further, instead of the server, each portable terminal may be provided with the identifying unit for identifying the room where the terminal is located. In this case, for example, in each room, preferably near the entrance, a transmitter is arranged for transmitting room identification information, such as a room number, which identifies the room. With this, the portable terminal receives the room identification information from transmitter, and thus the room can be identified.

In the above embodiments, while the server 20 is described as including the storage 20a that stores medical information processing applications each associated with a room, each portable terminal rather than the server may include a storage that corresponds to the storage 20a.

In the above embodiments, although each room is directly associated with a medical information processing application, it may be associated with application identification information, such as an application ID, which identifies the medical information processing application. In this case, the medical information processing applications are stored in association with the application identification information. Thus, when a room is identified, application identification information associated with the room is specified, and a medical information processing application corresponding to the application identification information is activated.

The portable terminal 10 (10′, 10″) of the above embodiments and modifications thereof may include one or more processing circuitries. The functions of the portable terminal 10 (10′, 10″) are implemented as a computer program stored in a computer readable medium such as a memory circuit. The processing circuitry loads the computer program from the memory circuit and executes it, thereby realizing the functions of the portable terminal 10 (10′, 10″). The computer program may be directly installed in the processing circuitry instead of being stored in the memory circuit. In this case, the processing circuitry loads the computer program installed therein and executes it to realize the functions.

Similarly, the server 20 of the above embodiments and modifications thereof may include one or more processing circuitries. The functions of the server 20 are implemented as a computer program stored in a computer readable medium such as a memory circuit. The processing circuitry loads the computer program from the memory circuit and executes it, thereby realizing the functions of the server 20. The computer program may be directly installed in the processing circuitry instead of being stored in the memory circuit. In this case, the processing circuitry loads the computer program installed therein and executes it to realize the functions.

The processing circuitry of the embodiments and modifications thereof is an example of the processing circuitry set forth in the claims.

According to at least one embodiment described above, an application associated with the room where the portable terminal is located is automatically executed based on the position information of the portable terminal, and thereby medical information is displayed on the display. Accordingly, the doctor is not required to manually execute a necessary application each time he/she moves to another room. That is, with the medical information display system of the embodiment, the display control can be performed easily according to the location of the portable terminal.

While certain embodiments have been described, these embodiments have been presented by way of example only, and are not intended to limit the scope of the inventions. Indeed, the novel embodiments described herein may be embodied in a variety of other forms; further, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical information display system comprising:
a storage configured to store a medical information processing application in association with a room in a hospital, the medical information processing application being configured to display a processing result or medical information on a display in the hospital; and
processing circuitry configured to
acquire the medical information to be displayed on the display,
identify the room where a portable terminal is located, and
execute the medical information processing application associated with the room identified to display the processing result or the medical information on the display.

2. The medical information display system of claim 1, wherein the processing circuitry is further configured to
acquire position information indicating a current position of the portable terminal, and
identify the room where the portable terminal is located based on the position information.

3. The medical information display system claim 1, wherein
the storage is further configured to store the medical information in association with the room in the hospital, and
the processing circuitry is further configured to acquire the medical information associated with the room identified from the storage.

4. The medical information display system of claim 1, wherein
the storage is further configured to store the medical information processing application in association with the room and an operator of the portable terminal, and
the processing circuitry is further configured to execute the medical information processing application associated with the room identified and the operator of the portable terminal to display the processing result or the medical information on the display.

5. The medical information display system of claim 1, wherein
the portable terminal is configured to acquire a patient ID, and
the processing circuitry is further configured to acquire medical information corresponding to the patient ID.

6. The medical information display system of claim 1, wherein
the portable terminal is configured to acquire an identification signal from an RF tag attached to a subject, and
the processing circuitry is further configured to acquire medical information corresponding to the identification signal.

7. The medical information display system of claim 1, wherein
the storage is further configured to store a work list that presents contents of work performed by an operator in time series, and
the processing circuitry is further configured to acquire the medical information associated with the room identified based on a time indicated by the work list.

8. The medical information display system of claim 1, wherein
the portable terminal includes the display configured to display the processing result or the medical information, and
the processing circuitry is further configured to display the processing result or the medical information on the display.

9. The medical information display system of claim 1, wherein
the storage is further configured to store installation information for each room, the installation information indicating presence or absence of a display installed in the room, and
when a display is installed in the room identified, the processing circuitry displays the processing result or the medical information on the display.

10. The medical information display system of claim 1, wherein the storage is further configured to store a plurality of medical information processing applications each corresponding to type of medical information to be displayed.

11. The medical information display system of claim 10, wherein the medical information includes at least one of an electronic medical record, test information, and a medical image.

12. The medical information display system of claim 10, wherein
the display includes a plurality of displays, and
the processing circuitry is further configured to specify one of the displays according to the type of the medical information to display the processing result or the medical information on the display specified.

13. A server comprising:
a storage configured to store a medical information processing application in association with a room in a hospital, the medical information processing application being configured to display a processing result or medical information on a display in the hospital; and
processing circuitry configured to
identify the room where a portable terminal is located, and
execute the medical information processing application associated with the room identified to display the processing result or the medical information on the display.

14. A portable terminal comprising:
processing circuitry configured to acquire position information indicating a current position; and
a display configured to display medical information or a processing result obtained by execution of a medical information processing application retrieved based on the position information from a plurality of medical information processing applications for displaying the processing result or the medical information in each room in the hospital.
